(19) United States
(12) Patent Application Publication
(10) Pub. No.: US 2026/0155634 A1
(43) Pub. Date: Jun. 4, 2026

(54) SURGE ARRESTER

(71) Applicant: STREAMER, ELECTRIC COMPANY INC., Saint-Petersburg (RU)

(72) Inventor: Evgenii Yurievich ENKIN, Vsevolozhsk (RU)

(73) Assignee: STREAMER, ELECTRIC COMPANY INC., Saint-Petersburg (RU)

(21) Appl. No.: 18/724,922

(22) PCT Filed: Jan. 10, 2023
(86) PCT No.: PCT/RU2023/000003

§ 371 Date: Jun. 27, 2024

(30) Foreign Application Priority Data
Dec. 28, 2021 (RU) 2021139441

(51) Int. Cl. H01T 4/16; H01T 4/04; H02H 9/06

(52) U.S. Cl. CPC H01T 4/16; H01T 4/04; H02H 9/06

(57) ABSTRACT

The invention is a surge arrester that includes a housing and discharge modules. Discharge modules include insulating bodies and a plurality of electrodes placed in the insulating bodies and forming discharge gaps between themselves. The discharge modules are located in the housing and electrically connected in series. The mechanical strength of the housing is higher than the mechanical strength of the discharge modules. The technical result of the invention is to reduce the size of the surge arrester compared to surge arresters of the corresponding voltage classes.

### TECHNICAL FIELD

The invention relates to arresters and, in particular, surge arresters for protection against overvoltages, for example, lightning ones, of electrical installations, high-voltage power lines and electrical networks. The invention also relates to high-voltage power lines containing elements equipped with such surge arresters.

### THE STATE OF THE ART

Lightning discharges are one of the most dangerous phenomena for the operation of high-voltage power lines. During a lightning discharge, an overvoltage pulse passes through the power line, which can lead to an emergency shutdown of the power line due to the pulsed shutdown of the linear insulation and the occurrence of a short circuit, as well as to the failure of the electrical equipment connected to it.

As a solution to the problem of lightning overvoltages, the patent RU2319247 proposes a surge arrester for protecting electrical equipment or power lines, containing a housing, two main electrodes mechanically connected to the housing, and a plurality of varistors located between the main electrodes with mutual displacement at least along the longitudinal axis housings.

Varistors can be manufactured, for example, by casting molten material with non-linear electrical characteristics into a varistor mold. Varistors made in this way are placed in a housing between the main electrodes.

When such a surge arrester is exposed to a lightning surge voltage pulse, the resistance of the varistors drops sharply and the lightning surge current is discharged through the tower to the ground. As soon as the lightning overvoltage pulse passes, the resistance of the varistors is restored and the power line continues to operate uninterruptedly. This method of protecting electrical equipment from overvoltages is quite effective. At the same time, the above-described surge arrester has such disadvantages as insufficient strength during large current pulses flowing through varistors, for example, during direct lightning strikes on power lines. In addition, varistors are very sensitive to environmental climatic influences, such as temperature, precipitation, humidity, etc., and therefore significant efforts have to be made to isolate them from the environment. It is also necessary to note the fragility of surge arresters due to the rapid degradation of varistors even during normal operation.

### DISCLOSURE OF THE INVENTION

The object of the present invention is to eliminate the above-described disadvantages.

The object of the present invention is achieved by using a surge arrester that includes a housing and discharge modules. The discharge modules include insulating bodies and a plurality of electrodes placed in insulating bodies with discharge gaps between them. The discharge modules are located in the housing and are electrically connected in series. The mechanical strength of the housing must be higher than the mechanical strength of the discharge modules.

The discharge gaps are advantageously isolated (hermetically or not hermetically) by the housing from the external space. The discharge gaps can be isolated (hermetically or non-hermetically) in discharge modules. The surge arrester electrodes preferably form a plurality of consecutive discharge gaps, the total number of which (i.e., successive discharge gaps between the surge arrester electrodes) is not less than the operating voltage of the surge arrester divided by the near-electrode voltage drop. In addition, the electrodes of the surge arrester preferably form a plurality of consecutive discharge gaps, the total number of which (i.e., successive discharge gaps between the electrodes of the surge arrester) is not more than the operating voltage of the surge arrester divided by 10 or 50 or 100 or 500 or 1000 values of the near-electrode voltage drop.

In particular, the surge arrester electrodes can form a plurality of consecutive discharge gaps, the total number of which (i.e., successive discharge gaps between the surge arrester electrodes) is not less than the operating voltage of the surge arrester divided by 500 V or 300 V or 200 V or 100 V or 50 V or 30 V or 20 V or 15 V or 10 V and/or not more than the operating voltage of the surge arrester divided by 30 V or 20 V or 15 V or 10 V or 5 V or 1 V or 0.5 V.

The discharge module may contain not less than 10 or 15 or 20 or 30 or 50 or 100 or 150 or 200 or 300 or 500 electrodes and/or not more than 20 or 30 or 50 or 100 or 150 or 200 or 300 or 500 or 1000 or 1500 or 2000 or 3000 or 5000 electrodes. In addition, the surge arrester can contain not less than 2 or 3 or 5 or 10 or 15 or 20 or 30 or 50 or 75 or 100 or 150 or 200 or 300 or 500 discharge modules and/or not more than 10 or 15 or 20 or 30 or 50 or 75 or 100 or 150 or 200 or 300 or 500 or 1000 or 1500 or 2000 or 3000 discharge modules.

The electrodes are preferably arranged to form discharge gaps (i.e., essentially with discharge gaps between them) with a value not more than 0.1 mm or 0.2 mm or 0.3 mm or 0.5 mm or 0.7 mm or 1 mm or 1.2 mm or 1.5 mm. In addition, the electrodes are preferably arranged to form discharge gaps (i.e., essentially, with discharge gaps between them) with the value not less than 0.01 mm or 0.02 mm or 0.03 mm or 0.05 mm or 0.07 mm or 0.1 mm or 0.2 mm or 0.3 mm or 0.5 mm or 0.7 mm or 1 mm.

The electrical connection of discharge modules can be carried out by direct connection of their electrodes or through discharge gaps. The insulating bodies of the discharge modules can be made using a polymer material or, for example, silicone rubber. The housing can be made with use of a polymer material and/or metal and/or a composite structure and/or braided reinforcement. The housing can include a pipe that may be configured to contain and/or secure discharge modules therein. The discharge modules may be made in a form of disks, and the housing may include a cylindrical pipe, the inner diameter of which is greater than the outer diameter of the discharge modules. The surge arrester may contain at least one or more varistors connected in series and/or in parallel with the discharge modules.

The technical result of the invention is an increase of reliability of the surge arrester compared to surge arresters containing only varistors as nonlinear or limiting elements. The increase of reliability consists in a longer service life and greater resistance to external influences, such as high currents due to lightning strikes of increased power and adverse climatic influences (humidity, temperature, etc.).

In particular, the surge arrester can pass stronger currents through itself without degradation of its properties or elements (or while maintaining operability) than varistor surge arresters. Higher currents are caused by lightning strikes closer to the power line, as well as direct lightning strikes (DLS). As a result of high currents flowing through the varistors and caused by more powerful overvoltages appearing in the power line as a result of close and direct lightning strikes, the varistors are destroyed or rapidly degrade due to strong heating and other related factors, and surge arresters of the prior art very quickly go out of service, that creates a threat of lightning overvoltage for electrical equipment.

The proposed overvoltage limiter with multi-electrode multi-gap discharge modules retain their operational properties even after the passage of currents caused by the DLS. Even in cases where varistors are used as part of the proposed surge arrester and these varistors are destroyed or their properties are degraded, the multi-electrode multi-gap discharge modules only heat up slightly and continue to perform their functions of overvoltage protection—this means that the proposed surge arrester is more reliable in terms of compared to arresters of the prior art. Even if the overvoltage pulse is too large, the surge arrester in accordance with the present invention has time to pass through itself the current necessary to limit the overvoltage, and only then can destruction processes begin—this is due to the fact that electrical processes occur much faster than mechanical ones.

In addition, the reliability of the surge arrester is increased due to the fact that multi-electrode multi-gap discharge modules are not destroyed, or degrade much more slowly than varistors, even during normal operation of the surge arrester. This means that the surge arrester according to the present invention, without the use of varistors, will retain its properties longer than the surge arrester of the prior art. Even in embodiments where the surge arrester of the present invention uses varistors, it will still maintain its performance and protective properties longer than a prior art surge arrester with varistors only. This also indicates the increased reliability of the proposed surge arrester.

It should also be noted that the surge arrester in accordance with the present invention is less sensitive to the tightness of the housing compared to the surge arresters of the prior art. Multi-electrode multi-gap discharge modules do not collapse or degrade without tightness, which significantly increases their reliability and service life compared to varistors. Even in those embodiments when the surge arrester in accordance with the present invention uses varistors in its configuration, it is still more reliable, because when the housing is unsealed, it will retain its functionality and protective characteristics, unlike a surge arrester of the prior art with only varistors, because after the destruction of the varistors, the protective function will continue to be performed by multi-electrode multi-gap discharge modules.

All above-mentioned factors indicate increased reliability of the surge arrester in accordance with the present invention.

### BRIEF DESCRIPTION OF DRAWINGS

FIG. 1 shows the configuration of the discharge module in partial section.

FIG. 2 shows the design of the surge arrester in a partial section.

### EMBODIMENT OF THE INVENTION

The present invention is further described with reference to the accompanying drawings and particular embodiments. This description is given for the purpose of explaining the invention by specific examples and is not intended to limit the scope of protection of the present invention, which is defined by the claims. At the same time, if necessary, the claims may include features from the description in order to more precisely determine the scope of protection.

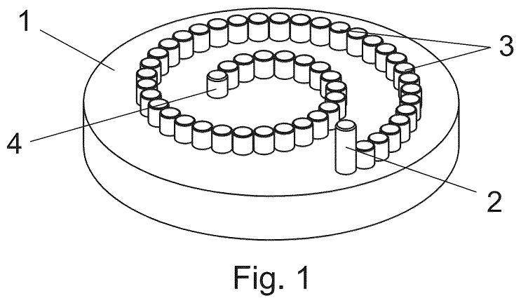

FIG. 1 shows a partial sectional view of a disk-shaped discharge module. The disk shape is only one of the possible embodiments of the discharge module and its choice for illustration of the invention is based on a simpler implementation of the surge arrester in the form of a cylinder, which provides increased strength. In other embodiments, other forms of discharge modules and the surge arrester in general are possible, which are included in the scope of protection of the invention.

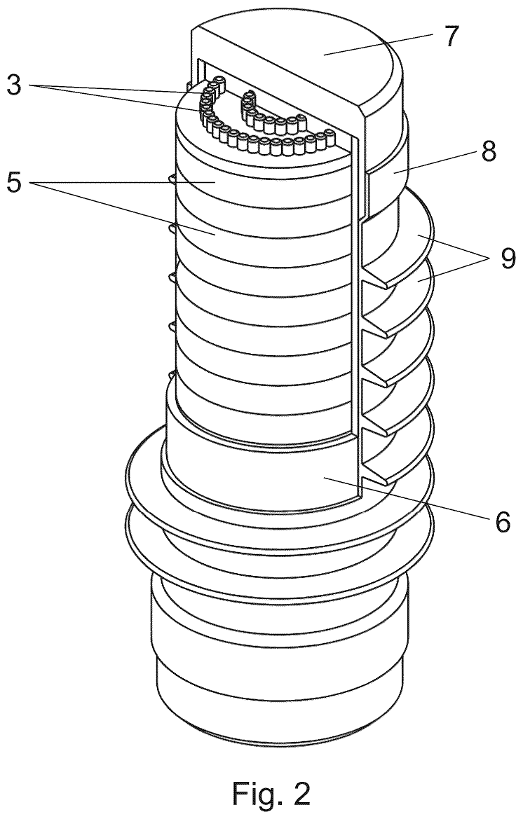

The insulating body 1 is shown only halfway to make the arrangement of the electrodes 2-4 clearer. In its full form, the discharge module can be seen in FIG. 2, where all modules, except the top one, are shown in their entirety, without a section. In FIG. 1, the electrodes 3 protruding from the partially shown insulating body 1 are in fact completely covered by the dielectric material of which the insulating body is made, and are thus completely contained in the insulating body. The electrodes 2 and 4 partially protrude from the insulating body 1, as described further.

The discharge module consists of an insulating body 1 and a plurality of electrodes 2, 3 and 4 located in the insulating body and forming discharge gaps between themselves. The insulating bodies of the discharge modules are preferably made with use of dielectric materials such as polymeric materials, for example silicone rubber. Thanks to the use of such materials, the manufacture of discharge modules, as well as the assembly of a surge arrester using these modules, becomes simpler and more technologically advanced. In addition, the plastic and elastic properties of the insulating bodies of discharge modules made with use of such materials make it possible to further increase the strength of the surge arrester as a whole, as will be shown further.

Also, because of such discharge modules, the main technical result of the present invention is achieved, namely, increasing the reliability of surge arresters compared to surge arresters that include exclusively varistors. This is due to the fact that the materials used for the manufacturing of the insulating body of the discharge module—for example, polymer materials, including silicone rubber, are more resistant to electrical influences and adverse climatic influences than metal-oxide materials of varistors.

Electrodes 2 and 4 are the outermost electrodes that allow the discharge modules to be connected to each other, and can therefore be called connecting electrodes. They are designed to supply voltage (including overvoltage) to the discharge module and for this purpose can protrude from the insulating body, or it can be possible to connect to them through the insulating body, if located completely in it, using connecting electrodes passed through a soft insulating body (for example made of silicone) or through a hole in the insulating body. For example, in FIG. 1, the electrode 2 protrudes onto one (lower) side of the disk-shaped discharge module, and the electrode 4 protrudes onto the other (upper) side of the discharge module.

The electrodes 3 are intermediate electrodes located between the connecting electrodes 2 and 4, not necessarily geometrically, but in the sense that the discharge begins between one connecting electrode and the intermediate electrode closest to it (for example, exiting into the same discharge chamber as the main electrode), then—the discharges sequentially develop in the discharge chambers between the intermediate electrodes and last one is in the discharge gap between the last intermediate electrode and the second connecting electrode. The connecting electrodes can be connected to adjacent intermediate electrodes directly or, preferably, through discharge gaps in the discharge chambers—that is, located with discharge gaps between them in the discharge chambers. When directly connected to adjacent intermediate electrodes, the first and last discharges develop between the intermediate electrodes.

The connection of the discharge modules can be ensured without protrusion of the connecting electrodes from the insulating bodies of the modules. For example, the outer surface of the connecting electrodes may be a continuation of the surface of the insulating body or be close to it, for example, with a slight depression. Then the connecting electrodes of adjacent discharge modules can be connected directly by contacting each other when the modules come into contact with each other or using additional electrodes. Moreover, the discharge modules can be installed in a way providing discharge gaps between their electrodes (meaning connecting electrodes). In this case, it can be said that the discharge modules are connected using a discharge gap when the connecting electrodes of adjacent modules are located opposite each other.

In addition, the connecting electrodes can be buried in the insulating bodies in an open or closed manner (in the latter case, they are covered with the material of the insulating body) and connected with use of additional electrodes installed between the connecting electrodes when the surge arrester is assembled. Additional electrodes can pass through the insulating body to the connecting electrodes through holes (recesses) in the insulating body formed during their manufacture or when passing through the insulating body of additional electrodes. If the connecting electrodes contain holes, additional electrodes can also pass through these holes.

The connecting and intermediate electrodes may be collectively referred to simply as electrodes. Electrodes can be made with use of conductive materials, including graphite and metals, such as steel, aluminum, copper, tungsten and other known alloys. There can be any shape of the electrodes, which provides the possibility of discharges between the electrodes. For example, electrodes can be made in the form of balls, cylinders, rings, pipes, ellipsoids, disks, prisms, etc.

The manufacturing of the electrodes from the mentioned conductive materials increases the reliability of the discharge modules and the proposed surge arrester in general, because the mentioned conductive materials have greater robustness to electrical influences and adverse climatic influences than metal-oxide varistor materials. At the same time, neither the materials of the insulating body nor the electrodes of the discharge modules have the nonlinearity of electrical properties characteristic of metal-oxide materials used for the manufacture of varistors. The nonlinearity of the properties of discharge modules, in particular their electrical resistance, is ensured by the presence of discharge gaps between the electrodes.

Due to use of multiple electrodes with multiple discharge gaps between them, the discharge voltage in each discharge gap is reduced because the total discharge voltage supplied to the surge arrester in general and to each of its discharge modules in particular is divided by the total number of discharge gaps. Thus, in each discharge gap there is a voltage that is the total number of discharge gaps in the surge arrester less than the voltage or the overvoltage applied to the surge arrester. This allows to reduce the requirements for the electrical and mechanical properties (in particular, strength) of materials used for the manufacture of discharge modules, and as a result of that the implementation of insulating bodies of discharge modules with use of polymer materials including silicone rubber becomes possible. Moreover, reduce of the discharge voltages in each discharge gap allows to reduce their size, which opens up the possibility of making the surge arrester in accordance with the present invention more compact, for example, in the same dimensions as prior art surge arresters using varistors.

FIG. 2 shows the overall design of the surge arrester. Discharge modules 5, which structure is shown in detail in FIG. 1 and also in FIG. 2 for the upper module (in particular, the electrodes 3 installed in the insulating body 1 are visible), are placed in the housing 6 and are electrically connected in series. The electrical connection of the modules is carried out by connecting the connecting electrodes of adjacent discharge modules to each other. In particular, a connecting electrode extending upward from the lower discharge module may be connected to a connecting electrode extending downward from the upper discharge module. The connection is preferably a direct electrical connection, but a connection with use of discharge gaps between the connecting electrodes of adjacent discharge modules can also be used—in this case, the electrical discharge will transfer to adjacent modules through the breakdown of the discharge gaps, through which electric current begins to flow in the form of a spark.

Thus, when discharge modules are installed with a discharge gap between the connecting electrodes of adjacent modules, the discharge gap itself represents an electrical connection of the connecting electrodes of the adjacent discharge modules when the discharge gap is broken down by an overvoltage pulse with the formation of a discharge arc (current), despite the fact that the discharge gap actually separates these connecting electrodes in the absence of overvoltage and discharge arc. However, due to the arrangement of the connecting electrodes of the adjacent discharge modules in such a way that they form discharge gaps between themselves (preferably one between each pair), the connecting electrodes can be considered electrically connected to each other. This method of electrically connecting the connecting electrodes of the adjacent discharge modules—through discharge gaps—provides an additional advantage to the present invention, namely that additional discharge gaps are organized in the surge arrester, which additionally reduces the discharge voltage on each of them and, therefore, further increases reliability of the surge arrester.

The housing preferably includes a tube within which the discharge modules can be placed and/or secured. Placing discharge modules in the housing, including the pipe, means placing discharge modules inside the housing (for example, the pipe). For example, they can be inserted through an opening in the housing or placed in one part of the housing and then closed by another part of the housing. In order to make placing of the discharge modules in the housing (the pipe) possible, they are preferably smaller than the internal dimensions of the housing (the pipe). However, in some embodiments, the discharge modules may have the same dimensions as the internal dimensions of the housing (the pipe), or even larger—in the latter case, they can be compressed, rolled, or otherwise change shape to be arranged within the housing (the pipe).

The discharge modules are preferably mounted within the housing (e.g., inside the pipe). Fixing can be done by mechanical, thermal, chemical or other methods. For example, discharge modules can be secured inside the housing (pipe) due to mechanical fasteners (threaded, snap-on, winding, pressing up, etc.), due to an interference fit, when the modules are clamped inside the housing (pipe) due to compression of the modules, the size of which slightly exceeds the internal size of the housing (pipe), and other mechanical fastening methods, or by enveloping the discharge modules with the housing (pipe with end elements) on all sides. In other embodiments, discharge modules can be secured inside the housing (pipe) using thermal connection methods, such as soldering, welding, thermal compression/expansion of materials (these methods, among others, are used or can be used to implement mechanical methods of fastening). In addition, the discharge modules can be fixed inside the housing (pipe) using chemical methods such as gluing, partial dissolution, fusion, etc.

Due to the length of the pipe in the longitudinal direction, a various number of discharge modules can be placed in it in accordance with the voltage for which the surge arrester is designed, and the length of the pipe can be technologically varied in accordance with the number of discharge modules by cutting or sawing. In particular, as FIG. 2 shows, the housing can include a cylindrical pipe, the use of which simplifies the manufacture or selection of a pipe of the required size, and also increases the strength of the housing, because the cylindrical body evenly distributes stress without concentrations. Disk discharge modules are advantageously used in the cylindrical pipe. In other versions, the pipe can have not a round cross-section, but oval, elliptical, polygonal, etc. The shape of the discharge modules must correspond to the internal shape of the housing and can also be not only round (disk), but also oval, elliptical, polygonal, prismatic, etc.

In the embodiment shown in FIG. 2, the housing 6 of the surge arrester is equipped with electrodes 7 that provide voltage supply to the discharge modules; for that reason the electrodes 7 can be connected to the connecting electrodes of the outer discharge modules directly or through the discharge gaps. The electrodes 7 may be referred to as main electrodes. As can be seen in FIG. 2, the electrodes 7 are covers that cover the housing 6. For example, the electrodes 7 can be put on the housing 6 or screwed onto it if a threaded connection is provided, which provides increased strength to such a connection and the surge arrester as a whole. In this form, the electrodes are part of the housing, since they ensure the retention of the discharge modules 5 inside the housing 6. However, other options for implementation of the housing and providing voltage supply to the discharge modules are also possible. In particular, the connecting electrodes of the outer discharge modules can pass through the housing and voltage can be applied directly to them—in this case, there is no need for electrodes 7.

The dimensions of the discharge modules and the housing as a whole preferably correspond to the dimensions of the varistors and the housing of surge arresters of the prior art. This makes it possible to simply and conveniently replace the surge arresters from old to new ones. In addition, in voltage limiters, varistors can be replaced by discharge modules and vice versa. Replacing individual discharge modules with varistors in some cases makes it possible to improve the nonlinear properties of the proposed surge arrester. With such a replacement, varistors can be connected in series with the discharge modules and/or in parallel with them.

As to replacing varistors with discharge modules in conventional surge arresters from the prior art, this is impossible due to the fact that the housings of surge arresters from the prior art do not have the increased strength required for discharge modules, because for varistors it is enough to ensure the tightness of the housing, which prevents adverse climatic influences on varistors, and the varistors have sufficient mechanical strength themselves. In addition, increasing the strength of the housing of surge arresters from the prior art would not lead to greater reliability of the operation of the varistors, because the varistors are destroyed and split when strong currents pass not due to possible expansion, but due to thermal effects and concentration of currents on the inhomogeneities of the internal structure of the varistors.

For the discharge modules of the surge arrester in accordance with the present invention, an outer housing with increased strength is required because the discharge modules themselves have a soft and fragile insulating body that is prone to destruction due to an increase in its size. When discharges pass in the discharge gaps between the electrodes, the internal gases are heated, which increases the internal pressure on the insulating body and electrodes. Due to this pressure from the inside out, the soft and elastic insulating body tends to expand, which ultimately leads to its cracking and destruction, unless such expansion of the insulating body is limited by a durable housing that has greater strength than the discharge modules and thereby restrains the expansion of the discharge modules.

On the other hand, the insulating body should preferably be elastic, because this ensures the performance of the discharge modules due to the fact that the electrodes inside such an elastic insulating body can move relative to each other, thereby increasing the discharge gaps during discharges. Increasing the discharge gaps will be especially useful when it is large relative to the size of the gaps themselves, that is, with discharge gaps of a fraction of a millimeter (for example, from 0.01 to 0.9 mm (or 1 mm) or from 0.1 to 0.5 mm). Thanks to this increase of gaps, when the electrodes move apart, there are created more favorable conditions for extinguishing discharges at the end of the overvoltage pulse, and the discharge modules remain operational longer, because the discharge gaps are less susceptible to sintering.

Thus, to ensure increased reliability of the insulating body, it should preferably be made of elastic materials, such as polymeric ones, for example silicone rubber. The mechanical strength of the housing should be higher than the mechanical strength of the discharge modules also to increase the reliability of the proposed surge arrester, because this helps prevent the destruction of discharge modules, which insulating bodies are made with use of elastic (soft) and/or hard (hard) materials.

To ensure increased mechanical strength compared to discharge modules, the housing can be made with use of metal, durable polymer material (more durable than that used for discharge modules), composite structure (composite materials) and/or reinforcement braid, fiberglass, carbon fiber and other durable materials. At the same time, it must be taken into account that the use of these materials and/or elements separately or even together for the manufacture of the housing does not ensure in itself the strength of the housing greater than the strength of the discharge modules. Options are possible when, for example, even metal, polymer material, composite structure, braided reinforcement or fiberglass in the housing can become tom, while the discharge modules remain intact, which means that the discharge module is stronger than the housing. The strength ratio is determined by the designs of the housing and discharge modules, as well as the materials used in their designs, in the aggregate.

The excess of the mechanical strength of the housing over the mechanical strength of the discharge modules is necessary because the discharge modules cannot provide sufficient strength for themselves. This is also due to the fact that the manufacture of discharge modules from materials of increased strength is low-tech, in contrast to the use of flexible and elastic polymer materials, such as silicone rubber, which can be poured or pressed into a mold for the manufacture of the discharge module and subsequently vulcanized, polymerized or cured—that is, to fixate, secure the configuration (shape) of the discharge modules.

Polymer materials, including silicone rubber, can provide the necessary electrical strength of the discharge modules, which is expressed in the ability to pass a huge number of overvoltage pulses through the discharge modules without changing the electrical properties, for example, specific resistivity, of the dielectric material, which is used to make the discharge module, However, to achieve the required electrical strength, it is necessary to ensure mechanical strength, that is, the ability to withstand discharges without mechanical damage or destruction. This requirement is due to the fact that electrical discharges release a large amount of energy, which leads to heating of the gases and a sharp increase in pressure on the insulating body in which the discharges occur.

In accordance with the present invention, the mechanical strength of the discharge modules is provided by the housing that surrounds them and prevents the gas pressure in the discharge gaps from destroying the discharge modules due to the “back pressure” provided by the strong walls of the housing. The forces caused by the gas pressure trying to rupture the insulating bodies of the discharge modules meet oppositely directed counterforces imparted to the insulating bodies of the discharge modules by the walls of the durable housing: as a result of that the insulating body experiences only a compressive effect and not a rupturing one.

The comparison of the strengths of the housing and the discharge modules is carried out in a direction perpendicular to the longitudinal (in FIGS. 1 and 2—in the horizontal direction), because, as FIG. 2 shows, the discharge modules are placed one above the other and, for the most part, the mechanical impact in the longitudinal (vertical) direction is perceived and mutually compensated by adjacent discharge modules on both sides. The outer discharge modules act on the covers covering the ends of the housing, which in the embodiment shown in FIG. 2, are made in the form of main electrodes. The covers are firmly attached to the housing and exert back pressure on the outer discharge modules in the longitudinal direction. In the direction transverse to the longitudinal (i.e. horizontal in FIG. 2), the pressure that appears in the discharge modules due to electrical discharges in the discharge gaps acts on the walls of the housing and, as a result, it is in this direction that the housing should be stronger than the discharge modules.

Comparison of strengths can be carried out by mechanical action, for example, until the structure of the housing or discharge module is destroyed. For example, if, under the same mechanical force (pressure), the discharge module or column of discharge modules deformed more than the housing (without modules) or even collapsed (for example, cracks appeared in them or they separated into several parts), while the case still retains its integrity, this means that the case is stronger than the discharge modules.

The housing can be covered with a protective coating 8, which can be equipped with ribs 9 that increase the length of the current leakage path along the surface. The coating and ribs can be made using polymer materials, including silicone rubber. In some versions, ribs may be missing. The coating is necessary to protect the housing from destructive environmental influences, and also increases the strength and reliability of the surge arrester.

In order to prevent discharge arcs from exiting the surge arrester, which makes it possible to place a larger number of the electrodes in the discharge modules and form a larger number of the discharge gaps between them, which reduces the discharge voltage, the discharge gaps are preferably hermetically sealed by the housing from the external space. In this embodiment, the discharge arcs can exit the discharge gaps outward from the discharge modules, for example, through the exits from the discharge chambers in which the discharge gaps are located, but they cannot exit the surge arrester because the walls of the housing block their path. Due to this, there is no need to prevent the arcs from merging into one, and there is no need to provide a place for the safe exhaust of the arcs outside the housing.

In a preferred embodiment, the discharge gaps are hermetically sealed directly in the discharge modules. For such insulation, it is sufficient not to provide exits for discharge arcs from the discharge gaps outside the discharge module. For example, this can be done by surrounding the discharge gaps on all sides not occupied by electrodes with dielectric material of the insulating body (for example, silicone rubber). As a result, closed, sealed discharge chambers are formed near the discharge gaps between adjacent electrodes. Due to the mechanical strength of the discharge modules, provided by the increased mechanical strength of the housing, discharge arcs will not be able to escape from the sealed discharge chambers and will be localized only directly in the discharge gaps. Thanks to this, even more electrodes can be placed in the discharge modules and an even larger number of discharge gaps can be formed between them, which further reduce the discharge voltage. In addition, this increases the reliability of the discharge arrester as a whole, because in this embodiment, the tightness of the housing is not mandatory, that is, the housing may be leaky or depressurized, and in such embodiments, the discharge modules, unlike varistors, will retain their properties and the surge arrester can be exploited longer.

At the same time, it should be noted that the discharge gaps can be isolated directly in the discharge modules or by the housing from the external space without ensuring the tightness of such insulation. Non-hermetic insulation means that the discharge gaps are closed to direct entry into them (and exit from them) from the external space or from the space between the discharge modules and the housing, but at the same time they can be entered through an indirect path, which also allows discharge gas to exit from the discharge chambers also along an indirect path. For example, this may be provided by walls or areas in the discharge module or housing that cover the discharge gaps (ie, they are not visible due to such walls or areas), but still leave gaps or slits for gases to exit the discharge modules from the side or on a distance from the discharge gaps.

FIG. 1 shows the embodiment where the electrodes are arranged in a spiral. If the discharge chambers had exits to the outside of the discharge module, then only one electrode could be placed at each radius of the module, because the second electrodes would prevent the formation of exits from the discharge chambers. However, FIG. 1 shows that at some radil there are two electrodes, which became possible due to the fact that the discharge chambers are closed and there is no need to form exits from the discharge chambers. Thus, making the discharge chambers closed (sealed) ensures that a larger number of electrodes are placed in the discharge modules with the formation of successive discharge gaps between them.

Thus, in accordance with the present invention, the discharge modules or the housing of the surge arrester, where the discharge modules are located, or both the discharge modules and the housing can be hermetically sealed. In the latter embodiment, additionally increased reliability of the surge arrester can be ensured. However, in those cases where only either the discharge modules (and the housing is not sealed) or the housing (and the discharge modules are not sealed) are sealed, an increase in the reliability of the surge arrester is also achieved. In general, the surge arrester will be operational and reliable even in the case where neither its housing nor its discharge modules are sealed, since discharge currents will pass through all discharge gaps, and the output of discharge arcs and discharge products can be limited by both discharge modules and the housing including their mutual arrangement in way when they, not being sealed individually, limit the possibility of discharge arcs and discharge products from each of them.

Arrangement of electrodes to form discharge gaps of small size, for example, not more than 0.1 mm or 0.2 mm or 0.3 mm or 0.5 mm or 0.7 mm or 1 mm or 1.2 mm or 1.5 mm, ensures a reduction in the discharge voltage and energy released in the discharge gap during the discharge. The low released energy provides low heating of the gases in the discharge gap (for example, inside the discharge chamber, where this gap is located and which is preferably sealed), which leads to a slight increase in the pressure of these gases and, as a result, to a small impact on the insulating body of the discharge element and the housing of the surge arrester as a whole. This further improves the reliability of the surge arrester according to the present invention.

The minimum size of the discharge gap is determined by the technological features and operational properties of the electrodes, because the discharge gap must be maintained even after numerous discharges, incl. electrodes should not be sintered. To ensure the reliability of the surge arrester in accordance with the present invention, the electrodes are preferably arranged to form discharge gaps, for example, at least 0.01 mm or 0.02 mm or 0.03 mm or 0.05 mm or 0.07 mm or 0.1 mm or 0.2 mm or 0.3 mm or 0.5 mm or 0.7 mm or 1 mm.

Suppression of the discharges between the electrodes in such a surge arrester can occur when the industrial frequency current passes through zero. However, it is more preferable to extinguish the discharges immediately at the end of the overvoltage pulse. This can be achieved using the near-electrode (cathode) voltage drop, which is inherent in the electrical discharges. During an electrical discharge, electron emission occurs on one of the electrodes, which consumes a certain amount of energy, which leads to a near-electrode voltage drop.

In the presence of a near-electrode voltage drop, the discharge cannot be self-sustaining if the potential difference between the electrodes is less than the near-electrode voltage drop. Thus, the emission of electrons from the electrode stops, because the potential difference between the electrodes does not provide enough energy to remove the electron from the electrode. As a result, the arc discharge stops, becase there are no charge carriers in the discharge gap between the electrodes, and the arc is interrupted and cannot resume.

In the case when the near-electrode voltage drop is greater than the voltage that appears between adjacent electrodes, when operational (operating) voltage is applied to the surge arrester, that is, the voltage for which the surge arrester is designed for operation, the discharge arc will be extinguished automatically at the end of the overvoltage pulse, and also will not appear without overvoltage. To do this, the near-electrode voltage drop must be greater than the operating voltage of the surge arrester (for example, effective voltage or maximum voltage), divided by the number of consecutive discharge gaps.

This means that the surge arrester preferably contains as many electrodes (not less) as are sufficient to form such a number of consecutive discharge gaps that is not less than the operating voltage of the surge arrester (effective or maximum) divided by the near-electrode voltage drop. The maximum number of electrodes is determined from considerations of manufacturability, weight and size characteristics and can be, for example, not more than the operating voltage of the surge arrester (effective or maximum) divided by 10 or 50 or 100 or 500 or 1000 values of the near-electrode voltage drop.

The near-electrode voltage drop has different values for different materials. For some metals it can be 10-20 V, for others more or less, and also can differ for non-metallic electrically conductive materials. In this regard, the above characteristics can be formulated in an alternative way. In particular, the electrodes of the surge arrester preferably form a plurality of sequential discharge gaps, the total number of which is not less than the operating voltage of the surge arrester divided by 500 V or 300 V or 200 V or 100 V or 50 V or 30 V or 20 V or 15 V or 10 V. In addition, the surge arrester electrodes preferably form a plurality of sequential discharge gaps, the total number of which is not more than the operating voltage of the surge arrester divided by 30 V or 20 V or 15 V or 10 V or 5 V or 1 V or 0.5 V.

Due to use of the effect of the near-electrode voltage drop, it is possible to ensure that the discharge arcs break immediately at the end of the overvoltage pulse and, thereby, minimize the impact of the discharge arcs on the surge arrester, in particular, its discharge modules and, more specifically, the dielectric material from which the insulating bodies are made. All this makes it possible to further reduce the requirements for the materials used for the manufacture of insulating bodies of discharge modules and the housing of the surge arrester, since the pressure in the surge arrester that appears during the passage of an overvoltage pulse is reduced, which can further improve the manufacturability of the surge arrester.

The discharge module may contain at least 10 or 15 or 20 or 30 or 50 or 100 or 150 or 200 or 300 or 500 electrodes, depending on the design of the surge arrester, the operating voltage and the possible values of overvoltages. At the same time, the discharge module preferably contains not more than 20 or 30 or 50 or 100 or 150 or 200 or 300 or 500 or 1000 or 1500 or 2000 or 3000 or 5000 electrodes, depending on both the listed factors and limitations of weight and size.

The surge arrester as a whole can contain at least 2 or 3 or 5 or 10 or 15 or 20 or 30 or 50 or 75 or 100 or 150 or 200 or 300 or 500 discharge modules, depending on the design of the surge arrester, the operating voltage and the possible values of overvoltage. At the same time, the surge arrester preferably contains not more than 10 or 15 or 20 or 30 or 50 or 75 or 100 or 150 or 200 or 300 or 500 or 1000 or 1500 or 2000 or 3000 discharge modules, depending on both the listed factors and restrictions for weight and size.

The surge arrester is manufactured in several stages. First, the discharge modules and housing are manufactured and after that the surge arrester can be assembled. The manufacture of discharge modules is preferably carried out as follows. The electrodes are installed into the mold for manufacturing discharge modules, and then the mold is filled with a dielectric material, for example, a liquid or amorphous polymer. Next, the configuration (shape) of the discharge module is fixed, which can be done by vulcanization or polymerization or hardening of the dielectric material or other methods. An injection mold or a compression mold can be used as a mold for manufacturing the discharge module. The polymer is poured into the injection mold, and the polymer is pressed into the compression mold. The production of an insulating body can occur in one or several stages depending on the equipment, technology, shape and material of the insulating body, shape and relative position of the electrodes.

In the case where the discharge gaps are large enough, for example 1 mm or more, the distance between the electrodes can be reliably defined by holes or recesses in the mold into which the electrodes are installed and/or secured. If the discharge gaps are small, then in order to ensure specified distances between the electrodes, which will determine the size of the discharge gaps, the electrodes can be sequentially wound with wire, preferably having a high resistivity, for example, nichrome wire. As a result, the distance between the electrodes will be determined by the thickness of the wire. Subsequently, after completion of the manufacture of the insulating body, an electric current can be passed through the wireδ wherein the electric current has such magnitude that the wire will melt and be distributed over the surface of the electrodes, while the required discharge gaps will be formed between the electrodes inside the insulating body.

Manufacturing of the housing may involve, for example, cutting the pipe to the required size and preparing the covers. In particular, threads can be made in the covers and at the ends of the pipe.

The manufacture of the surge arrester from the prepared elements can proceed as follows. The discharge modules are placed in the housing (for example, the pipe) with ensuring the connection between the connecting electrodes of adjacent discharge modules in accordance with one of the above-described embodiments or with providing the discharge gaps between the connecting electrodes of the adjacent discharge modules according to another embodiment. The housing is closed with covers with ensuring that the connecting electrodes of the outer discharge modules exit the housing or with ensuring the connection of the connecting electrodes of the outer discharge modules with the external electrodes of the housing or with providing the possibility of forming discharge gaps with the connecting electrodes of the outer discharge modules in the housing and/or housing covers.

In the latter embodiment, the connecting electrodes of the outer discharge modules must be located in the housing, but they must be allowed to form discharge gaps with any external electrodes (for example, with the external electrodes of the housing or covers, if they are made in the form of electrodes) due to holes or recesses in the housing and/or housing covers or, if the covers are made in the form of electrodes, due to such an arrangement of the connecting electrodes of the outer discharge modules and covers, when there will be discharge gaps between them.

For example, the hole or recess in the housing can provide development of the electrical discharge through it and flowing of the discharge arc from the external electrode to the connecting electrode located at the bottom of the hole or recess in the housing. The hole or recess in the cover can allow provide development of the electrical discharge through it and flowing of the discharge arc from the external electrode to a connecting electrode located at the bottom of the hole or recess in the cover. In addition, a hole or recess made simultaneously in the body and cover (when the body and cover are located side by side and the hole or recess is made partly in the body and partly in the cover, or when the body and cover are superimposed on each other and the hole or recess is made as in housing and in the cover) can ensure the development of an electric discharge through it and the flow of a discharge arc from the external electrode to the connecting electrode located at the bottom of the hole or recess in the housing and cover.

The body of the surge arrester can further be covered with a protective coating.

As part of power lines, the surge arrester in accordance with the present invention can be used both on its own and as part of the above-mentioned protective elements—an insulator-discharger and/or a screen for protection against corona discharge. Power transmission lines typically comprise towers, single insulators and/or insulators assembled into columns or garlands, and at least one high-voltage wire connected directly or by means of fastening devices to the fittings of the single insulators and/or first column insulators or garlands of insulators, each single insulator or each column or garland of insulators is fixed to one of the towers by means of an element of its fitting adjacent to said tower. In accordance with the invention, the power transmission line contains at least one surge arrester according to any of the above-described embodiments and/or at least one screen-arrester according to the above-described embodiment and/or at least one of the insulators is an insulator-arrester according to the above described embodiment.

The use of a surge arrester in accordance with the present invention by itself or as part of insulators-arresters or screens to protect a high-voltage power line or other types of electrical installations from lightning overvoltages can increase the reliability of the operation of the power line, increase the service life of electrical equipment and reduce the cost of their operation.

The surge arrester works as follows. In the normal operating mode of electrical equipment (in the described example, power lines), the normal (operational) voltage of the power line is applied between the mounting location of the surge arrester (mainly a tower or part of a power line tower) and the protected object (for example, a wire). For example, the normal (operational) voltage corresponds to the voltage classes of the lines power transmission 6, 10, 15, 35 35, 110 KV or others. Such a voltage does not lead to breakdown of the discharge gaps and no current flows through the surge arrester—thus, in the normal mode, the surge arrester represents an electrical break.

If there is an overvoltage on the protected object, for example, as a result of a lightning discharge hitting it or passing near it, this overvoltage is applied to the surge arrester along with the discharge gap near the outer electrode of the surge arrester (if provided). As a result, discharge gaps are sequentially broken between the protected object and the outer or connecting electrode at the free end of the surge arrester, between the electrodes of the discharge modules and then between the electrode of the outer discharge module and the outer electrode of the surge arrester, which is connected to the power line tower. When the discharge reaches the outer electrode of the surge arrester mounted on the tower, the pulse current of the discharge (for example, lightning one) flows into the ground, since the tower is grounded, and thanks to this, the electrical equipment (the protected object) is protected from this overvoltage.

A surge arrester, according to the generally accepted classification, is a discharger. The above technical results are indicated mainly in comparison with prior art surge arresters using varistors. In comparison with other dischargers, for example multi-chamber ones, the present invention also has advantages, which also represent technical results. In particular, a reduction in the size of the surge arrester is achieved in comparison with surge arresters of the corresponding voltage classes. The reduction in size is ensured by the simultaneous use of modular design, which allows the electrodes to be placed volumetrically, excluding the discharge arcs from exiting the surge arrester, which allows the electrodes to be placed more densely, providing structural strength with the housing, which allows the use of less durable materials to ensure the necessary properties of the discharge modules, as well as the use the effect of near-electrode voltage drop, which makes it possible to reduce the requirements for the strength characteristics of the surge arrester and, thereby, further reduce the size of the surge arrester. Reducing the size of the surge arrester while maintaining the voltage class can also be represented as increasing the voltage class while maintaining the size of the surge arrester.

All technical results specified in the description, including additional ones, are achieved using a surge arrester in accordance with the present invention simultaneously and inextricably from each other.

All technical results specified in the description, including additional ones, are achieved with use of the surge arrester in accordance with the present invention simultaneously and inextricably from each other. The embodiments shown in the accompanying figures, as well as additional embodiments described in detail, are intended to facilitate understanding of the essence of the invention and should not be construed as limiting the scope of protection of the invention as defined by the following claims. The sequence of described actions and operations is not strictly specified and may vary unless otherwise indicated and this does not contradict physical feasibility. The described embodiments can be joined and combined in any combination that ensures the implementation of the operating principle and the achievement of the stated technical results. As a result of a combination of some embodiments, additional technical results can be achieved.

1. A surge arrester, including a housing and discharge modules, wherein the discharge modules include insulating bodies and a plurality of electrodes located in the insulating bodies with discharge gaps between them; wherein the discharge modules are located in the housing and electrically connected in series; wherein the mechanical strength of the housing is higher than the mechanical strength of the discharge modules.

2. The surge arrester according to claim 1, wherein the discharge gaps are isolated by the housing from the external space.

3. The surge arrester according to claim 1, wherein the discharge gaps are isolated in the discharge modules.

4. The surge arrester according to claim 1, wherein the total number of consecutive discharge gaps between the electrodes of the surge arrester is not less than the operating voltage of the surge arrester divided by the near-electrode voltage drop.

5. The surge arrester according to claim 1, wherein the total number of consecutive discharge gaps between the electrodes of the surge arrester is not more than the operating voltage of the surge arrester divided by 10 or 50 or 100 or 500 or 1000 values of the near-electrode voltage drop.

6. The surge arrester according to claim 1, wherein the total number of consecutive discharge gaps between the electrodes of the surge arrester is not less than the operating voltage of the surge arrester divided by 500 V or 300 V or 200 V or 100 V or 50 V or 30 V or 20 V or 15 V or 10 V.

7. The surge arrester according to claim 1, wherein the total number of consecutive discharge gaps between the electrodes of the surge arrester is not more than the operating voltage of the surge arrester divided by 30 V or 20 V or 15 V or 10 V or 5 V or 1 V or 0.5 V.

8. The surge arrester according to claim 1, wherein the discharge module contains at least 10 or 15 or 20 or 30 or 50 or 100 or 150 or 200 or 300 or 500 electrodes.

9. The surge arrester according to claim 1, wherein the discharge module contains not more than 20 or 30 or 50 or 100 or 150 or 200 or 300 or 500 or 1000 or 1500 or 2000 or 3000 or 5000 electrodes.

10. The surge arrester according to claim 1, wherein it contains at least 2 or 3 or 5 or 10 or 15 or 20 or 30 or 50 or 75 or 100 or 150 or 200 or 300 or 500 discharge modules.

11. The surge arrester according to claim 1, wherein it contains not more than 10 or 15 or 20 or 30 or 50 or 75 or 100 or 150 or 200 or 300 or 500 or 1000 or 1500 or 2000 or 3000 discharge modules.

12. The surge arrester according to claim 1, wherein the electrodes are located with the discharge gaps between them with a value of not more than 0.1 mm or 0.2 mm or 0.3 mm or 0.5 mm or 0.7 mm or 1 mm or 1.2 mm or 1.5 mm.

13. The surge arrester according to claim 1, wherein the electrodes are located with the discharge gaps between them with a value of at least 0.01 mm or 0.02 mm or 0.03 mm or 0.05 mm or 0.07 mm or 0, 1 mm or 0.2 mm or 0.3 mm or 0.5 mm or 0.7 mm or 1 mm.

14. The surge arrester according to claim 1, wherein the electrical connection of the discharge modules is carried out by direct connection of their electrodes or through discharge gaps.

15. The surge arrester according to claim 1, wherein the insulating bodies of the discharge modules are made with use of a polymer material, for example, silicone rubber.

16. The surge arrester according to claim 1, wherein the housing is made with use of a polymer material and/or metal and/or a composite structure and/or braided reinforcement.

17. The surge arrester according to claim 1, wherein the housing includes a pipe, etc.

18. The surge arrester according to claim 1, wherein it contains at least one or more varistors connected in series and/or parallel with the discharge modules.
